(19) United States
(12) Patent Application Publication
(10) Pub. No.: US 2019/0300645 A1
(43) Pub. Date: Oct. 3, 2019

(54) NEW HYDROCARBON POLYMERS WITH EXO-VINYLENE CYCLOCARBONATE END GROUPS

(71) Applicant: BOSTIK SA, La Plaine Saint-Denis (FR)

(72) Inventors: Guillaume MICHAUD, Compiegne (FR); Stephane FOUQUAY, Mont Saint-Aignan (FR); Frederic SIMON, Pont L'Eveque (FR)

(73) Assignee: BOSTIK SA, La Plaine Saint-Denis (FR)

(21) Appl. No.: 16/339,846

(22) PCT Filed: Oct. 2, 2017
(86) PCT No.: PCT/FR2017/052700

§ 371 Date: Apr. 5, 2019

(30) Foreign Application Priority Data
Oct. 7, 2016 (FR) 1659676

(51) Int. Cl. C08G 61/08; C08G 61/12; C09J 165/00; B01J 31/22

(52) U.S. Cl. CPC C08G 61/08; C08G 61/12; C08G 71/04; B01J 31/2278; C09J 165/00

(57) ABSTRACT

1) Hydrocarbon polymer of formula (I):

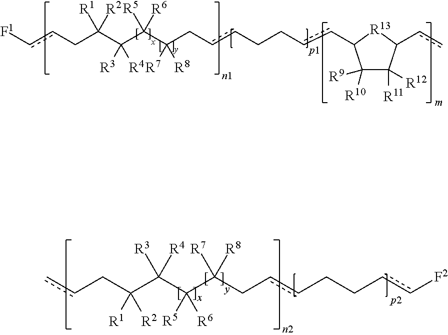

F¹ and F² are exo-vinylene cyclocarbonate monovalent radicals of formulas (IIa) and (IIb):

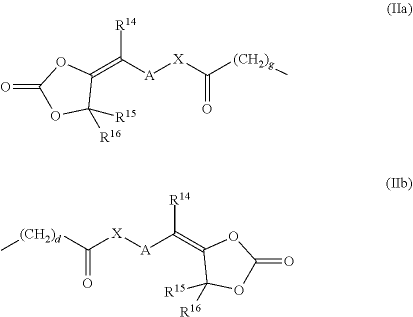

g and d 0, 1, 2 or 3; A C1-C6 alkyl; X an oxygen atom or NR¹⁷ with R¹⁷ C1-C6 alkyl;
R¹⁴, R¹⁵ and R¹⁶ a hydrogen atom or C1-C6 alkyl;
R¹ to R¹² H or C1-C14 alkyl; R¹³ O or —CH₂—; x 1 and y 1;
n1 and n2 an integer or zero; m an integer or zero; p1 and p2 an integer or zero of non-zero sum; n1, n2, m, p1 and p2 such that the molecular weight of said polymer is 400 to 100,000 g/mol; process of preparation by ring-opening metathesis polymerization; and use as an adhesive in a mixture with an amine compound having at least 2 amine groups.

The present invention relates to hydrocarbon polymers comprising two exo-vinylene cyclocarbonate end groups, their preparation process and use for the manufacture of coating, sealant or adhesive compositions.

It is known that polyurethanes are used in the manufacture of various coating, sealant or adhesive compositions.

These compositions may be in the form of one-component or two-component compositions. In the latter case, the reagents necessary for polyurethane synthesis are stored separately, possibly in the presence of other ingredients (additives), and are intended to be mixed before the composition is used, to synthesize polyurethane at the last moment.

Polyurethane synthesis is traditionally done by reacting a diisocyanate with a diol.

Diisocyanates are toxic compounds as such, and are generally obtained from phosgene, which is itself very toxic by inhalation or by contact. The manufacturing process used in the industry generally involves the reaction of an amine with an excess of phosgene to form an isocyanate.

Furthermore, polyisocyanates are very sensitive compounds in the presence of atmospheric moisture and there is need to take appropriate measures to prevent their premature crosslinking, and therefore their loss of reactivity, during handling and storage (anhydrous conditions).

The search for alternatives to polyurethane synthesis, without the use of isocyanate (or NIPU for “Non Isocyanate PolyUrethane” in English, meaning “polyurethane without isocyanate”), therefore represents a major challenge.

This research has been the subject of numerous studies. The most studied approaches concern the use of polymers capable of reacting with amines or amine oligomers to form polyurethanes or derivatives structurally close to polyurethanes.

Patent application WO 2014/091173 on behalf of Bostik and the CNRS, describes hydrocarbon polymers comprising two terminal (2-oxo-1,3-dioxolan-4-yl) terminating groups obtainable by ring-opening metathesis polymerization from at least one cyclic cycloolefin, at least one non-cyclic unsaturated chain transfer agent comprising a terminal group (2-oxo-1,3-dioxolan-4-yl), and at least one metathesis catalyst.

These polymers can then react with a (poly) amine to form polyurethanes without isocyanate with hydroxyl functions which can be used to formulate coating, sealant or adhesive compositions. However, this reaction is relatively slow and is in need of improvement.

The objective of the present invention is to provide novel polyurethane polymer synthesis intermediates, for the manufacture of coating compositions, sealants or adhesives, and overcoming all or part of the disadvantages of the prior art.

In particular, the purpose of the present invention is to provide new intermediates whose synthesis does not use isocyanates and which are capable of reacting more rapidly with a (poly) amine, compared to hydrocarbon polymers with terminations (2-oxo-1,3-dioxolan-4-yl) of patent application WO 2014/091173.

Thus, the present invention relates to a hydrocarbon polymer comprising two exo-vinylene cyclocarbonate end groups, said hydrocarbon polymer having the formula (I):

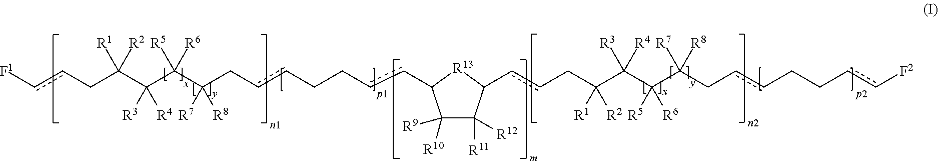

wherein:

F¹ and F² are the exo-vinylene cyclocarbonate monovalent radicals of the respective formulas (IIa) and (IIb):

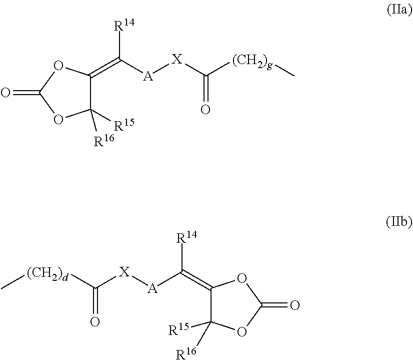

wherein:
   g and d, identical or different, represent an integer equal to 0, 1, 2 or 3;
   A represents a C1-C6 alkylene divalent radical;
   X is an oxygen atom or a nitrogen group NR¹⁷ where R¹⁷ is a C1-C6 alkyl group;
   R¹⁴, R¹⁵ and R¹⁶, which may be identical or different, each represent a hydrogen atom, a C1-C6 alkyl group, a C5-C6 cycloalkyl group, a phenyl group or an alkylphenyl group with a C1-C4 alkyl chain;
      each carbon-carbon bond of the main chain of the polymer, denoted [symbol] represents a double bond or a single bond, according to the valence rules of organic chemistry;

R¹, R², R³, R⁴, R⁵, R⁶, R⁷ and R⁸, identical or different, represent:
a hydrogen or halogen atom; or
a radical comprising from 1 to 22 carbon atoms selected from alkyl, alkenyl, alkoxycarbonyl, alkenyloxycarbonyl, alkylcarbonyloxy and alkenylcarbonyloxy, the hydrocarbon chain of said radical possibly being interrupted by at least one oxygen atom or one sulphur atom; in addition:
   at least one of the groups R¹ to R⁸ can form, with at least one other R¹ to R⁸ group including the carbon atom (s) to which said groups are attached, a saturated or unsaturated, optionally substituted, hydrocarbon ring or heterocycle comprising between 3 to 10 links; and
   at least one of the pairs (R¹, R²), (R³, R⁴), (R⁵, R⁶) and (R⁷, R⁸) can form, with the carbon atom to which said pair is connected, a carbonyl group C═O or a group of 2 carbon atoms connected by a double bond: C═C, the other carbon atom carrying 2 substituents selected from a hydrogen atom or a C₁-C₄ alkyl radical;

x and y are integers, identical or different, ranging from 0 to 6, the sum x+y ranging from 0 to 6;

R⁹, R¹⁰, R¹ and R¹², identical or different, represent:
a hydrogen or halogen atom; or
a radical comprising from 1 to 22 carbon atoms and selected from alkyl, alkenyl, alkoxycarbonyl, alkenyloxycarbonyl, alkylcarbonyloxy, alkenylcarbonyloxy and alkylcarbonyloxyalkyl, the hydrocarbon chain of said radical possibly being interrupted by at least one oxygen atom or one sulphur atom; in addition:
   at least one of the groups R⁹ to R¹² can form, with at least one other R⁹ to R¹² group including the carbon atom or atoms to which said groups are attached, a saturated or unsaturated, optionally substituted, hydrocarbon ring or heterocycle comprising from 3 to 10 links; and
   at least one of the pairs (R⁹, R¹⁰) and (R¹, R¹²) can form with the carbon atom to which said pair is connected, a group of 2 carbon atoms connected by a double bond: C═C, the other carbon atom of which bears 2 substituents selected from a hydrogen atom or a radical C1-C₄ alkyl radical; and
the carbon atom bearing one of the groups of the pair (R⁹, R¹⁰), can be connected to the carbon atom bearing one of the groups of the pair (R¹¹, R¹²) by a double bond, provided that, in accordance with valence rules, only one of the groups of each of these 2 pairs is then present;

R¹³ represents:
an oxygen or sulphur atom, or
a divalent radical —CH₂—, —C(═O)— or —NR⁰— wherein R⁰ is an alkyl or alkenyl radical comprising from 1 to 22 carbon atoms;

n1 and n2, which are identical or different, are each an integer or zero, the sum of which is denoted by n;

m is an integer greater than or equal to 0;

p1 and p2, which are identical or different, are each an integer or zero, the sum of which p1+p2 is non-zero and satisfies the equation: p1+p2=qx (z+1)

wherein:
q is an integer greater than 0; and
   z is an integer ranging from 1 to 5; and

n1, n2, m, p1 and p2 further being such that the number-average molecular weight Mn of the polymer of formula (I) is comprised in a range from 400 to 100,000 g/mol and its polymolecularity index is comprised in a range from 1.0 to 3.0.

The various groups, radicals and letters included in formula (I) and defined above, and, in the absence of clear indication to the contrary, maintain the same definition throughout this text.

The following variants of the polymer of formula (I), either individually or in combination, are particularly preferred:
g or d are equal to 0;
A represents a C1-C3 alkylene divalent radical;
X is an oxygen atom or a nitrogen group NR¹⁷ where R¹⁷ is a C1-C3 alkyl group;
R¹⁴ is a hydrogen atom;
R¹⁵ and R¹⁶, identical or different, each represent a C1-C3 alkyl group;
R¹, R², R³, R⁴, R⁵, R⁶, R⁷ and R⁸ represent a hydrogen atom or an alkyl radical comprising from 1 to 14 carbon atoms, and even more preferably from 1 to 8;
the integers x and y are in a range from 0 to 2, the sum x+y being in a range going from 0 to 2;
R⁹, R¹⁰, R¹¹ and R¹² represent a hydrogen atom or a radical the hydrocarbon portion of which comprises from 1 to 14 carbon atoms, and even more preferably from 1 to 8;
z is an integer equal to 1 or 2; and/or

the number-average molecular weight Mn ranges from 1000 to 50,000 g/mol, and the polydispersity index ranges from 1.4 to 2.0.

According to other more particularly preferred variants of the polymer of formula (I) taken either individually or in combination:
g and d are each equal to 0;
A represents the divalent radical —(CH₂)₂—;
X is the oxygen atom or the nitrogen group NR¹⁷ where R¹⁷ is the methyl radical;
R¹⁵ and R¹⁶ each are methyl;
x is 1 and y is 1;
at most one of the groups selected from (R¹, R², R³, R⁴, R⁵, R⁶, R⁷ and R⁸) is a C1-C₈ alkyl radical and all the others represent a hydrogen atom;
at most one of the groups selected from (R⁹, R¹⁰, R¹¹ and R¹²) is a C₁-C₈ alkoxycarbonyl radical and all the others represent a hydrogen atom; and/or
R¹³, represents a radical —CH₂— or an oxygen atom.

The main chain of the polymer of formula (I) thus comprises one, two or three repeating units:
a first repeating unit repeated p1+p2 times,
a second repeating unit, optional, repeated n1+n2 times; and
a third repeating unit, optional, repeated m times.

When the main chain of the polymer of formula (I) comprises several units, it is understood that the distribution of said units on said main chain is random, and that the polymer of formula (I) is then a random polymer.

As it appears above, the end groups F¹ and F² are generally symmetrical relative to the main chain, that is they correspond substantially, with the exception of g and d indexes.

“Heterocycle” refers to a hydrocarbon ring which may comprise an atom other than carbon in the ring chain, for example, oxygen, sulphur or nitrogen atoms.

“End group” refers to a group located at one of the two ends of the main chain of the polymer, which is constituted by one or more repeating units.

The polymolecularity index (also called in English polydispersity index or PDI) is defined as the Mw/Mn ratio, meaning the ratio of the weight average molecular weight to the number-average molecular weight of the polymer.

In the present text, the two average molecular weights Mn and Mw are measured by Size Exclusion Chromatography (SEC), also referred to as Gel Permeation Chromatography or by the corresponding acronym GPC. The implemented calibration is usually a PEG (PolyEthyleneGlycol) or PS (PolyStyrene) calibration, preferably PS.

If g=0 or d=0, then there is no radical —(CH₂)— in the radicals of formula (IIa) or (IIb). In other words, the radical: —(CH₂)_{g}— or —(CH₂)_{d}— is replaced by a simple bond.

When one of the indexes n1, n2, m, x or y that applies to a set of two brackets is equal to zero, this means there is no group between the brackets to which this index applies. For example, the group:

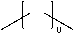

represents a simple bond: [symbol] , and the group:

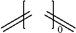

represents a double bond: ═.

The polymers of formula (I) according to the invention are particularly homogeneous and temperature-stable.

They can form, after a polyaddition reaction at a temperature below 100° C., or even at room temperature, with an amine compound comprising at least two amine groups (such as a primary and/or secondary polyamine) a polyurethane constituting an adhesive seal. The speed of said reaction is also advantageously faster than that offered by the hydrocarbon polymers comprising two end groups (2-oxo-1,3-dioxolan-4-yl) of the above-mentioned application WO2014/091173.

The adhesive seal thus formed exhibits high cohesive values, particularly greater than 1.5 MPa. Such cohesive values allow the said polymer to be used as an adhesive, for example as a sealing gland on a usual carrier (concrete, glass, marble), in the building field, or for bonding glazing in the automotive and naval industry.

The polymers of formula (I) according to the invention can be, at ambient temperature (i.e. around 20° C.), solids, viscous liquids or very fluid liquids.

When the polymer according to the invention is solid at room temperature, it is thermoplastic, that is, deformable and heat-fusible (i.e. at a temperature above room temperature). It can therefore be used, in combination with for example, a diamine, as a two-component thermofusible adhesive and applied hot on the interface of substrates to be assembled at their tangency surface. By solidifying at room temperature, an adhesive seal bonding the substrates and made of a polyurethane is quickly created, thus giving the adhesive advantageous properties of reduced setting time.

According to a first alternative of a preferred variant of the polymer in accordance with the invention, when m is non-zero and n1 and n2 are each equal to 0 (corresponding to the presence in the main chain of the polymer of the only 2 repeating units repeated p1+p2 times and m times respectively), thus the ratio:

m/(p1+p2+m)

ranges from 30 to 70%, and more preferably is about 50%.

According to a second alternative of this same preferred variant, when m is equal to 0 and the sum n1+n2 is non-zero (corresponding to the presence in the main chain of the polymer of the only 2 repeating units repeated p1+p2 times and n1+n2 times respectively), then at least one of the groups R¹, R², R³, R⁴, R⁵, R⁶, R⁷ and R⁸ is other than a hydrogen atom, hence the ratio:

(n1+n2)/(p1+p2+n1+n2)

ranges from 30 to 70%, and more preferably is about 50%.

According to a third alternative of said preferred variant, when m is non-zero, the sum n1+n2 is non-zero (corresponding to the presence in the main chain of the polymer of the 3 repeating units) and each of the groups R¹, R², R³, R⁴, R⁵, R⁶, R⁷ and R⁸ is a hydrogen atom, thus the ratio:

m/(p1+p2+n1+n2+m)

ranges from 30 to 70%, and more preferably is about 50%.

According to a fourth alternative of the said preferred variant, when m is non-zero, the sum n1+n2 is non-zero (corresponding to the presence in the main chain of the polymer of the 3 repeating units) and that at least one of the groups R¹, R², R³, R⁴, R⁵, R⁶, R⁷ and R⁸ is other than a hydrogen atom, thus the ratio:

(m+n1+n2)/(p1+p2+n1+n2+m)

ranges from 30 to 70%, and more preferably is about 50%.

In accordance with the 4 alternatives of said preferred variant, the polymer of formula (I) is generally in the form of a viscous liquid, generally having a Brookfield viscosity at 23° C. of between 1 mPa·s and 500 Pa-s, preferably between 1 to 150 Pa·s and even more preferably between 1 to 50 Pa·s. It is then advantageously easy to implement and can be combined with an additional component such as a tackifying resin or a filler, to form an adhesive composition.

In general, the viscosity can be measured in a manner well known to the person skilled in the art. In particular, the viscosity can be measured with a Brookfield viscometer, by appropriately selecting the needle and the module speed according to the viscosity range to be measured.

According to one embodiment of the invention, all the bonds [symbol] of formula (I) are carbon-carbon double bonds, and formula (I) then becomes the following formula (I′):

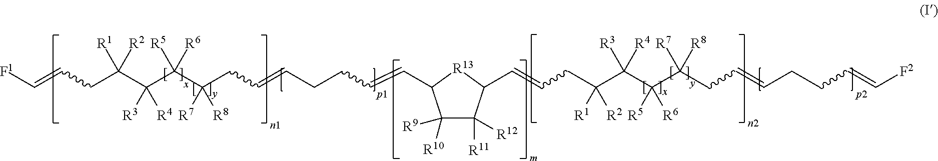

wherein x, y, n1, n2, m, p1, p2, F¹, F², R¹, R², R³, R⁴, R⁵, R⁶, R⁷, R⁸, R⁹, R¹⁰, R¹¹, R¹² and R¹³ are as previously defined and the bond [symbol] is a geometrically oriented bond on one end or the other in relation to the double bond (cis or trans).

Each of the double bonds of the polymer of formula (I′) is oriented geometrically cis or trans, preferably cis orientation. The geometric isomers of the polymer of formula (I′) are generally present in variable proportions, generally with a majority of cis (Z) oriented double bonds, and preferably all cis (Z) oriented. According to the invention, it is also possible to obtain only one of the geometric isomers, according to the reaction conditions and, in particular, according to the nature of the catalyst used.

According to another embodiment of the invention, all the bonds [symbol] of formula (I) are single carbon-carbon bonds, and the formula (I) then becomes formula (IH) below:

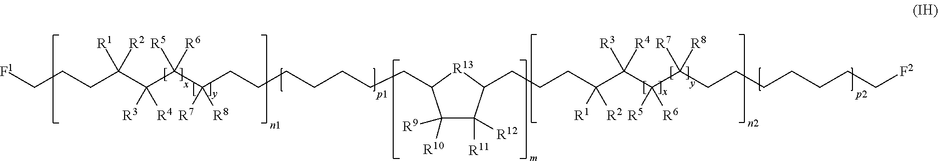

wherein x, y, n1, n2, m, p1, p2, F¹, F², R¹, R², R³, R⁴, R⁵, R⁶, R⁷, R⁸, R⁹, R¹⁰, R¹¹, R¹² and R¹³ are as previously defined.

The formula (IH) illustrates the case where the main chain of the polymer of formula (I) is saturated, that is, having only saturated bonds.

In this case, preferably, x is equal to 1 and y is equal to 1.

According to one embodiment of the polymer of formula (I) according to the invention, m is equal to 0, the polymer being of the following formula (II):

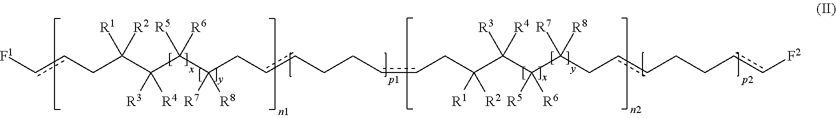

wherein x, y, n1, n2, p1, p2, F¹, F², R¹, R², R³, R⁴, R⁵, R⁶, R⁷ and R⁸, are as previously defined.

In a particularly preferred manner, x is equal to 1 and y is equal to 1.

According to a particularly preferred form of this embodiment, all the bonds [symbol] of formula (II) are carbon-carbon double bonds, and formula (II) then becomes the following formula (II′):

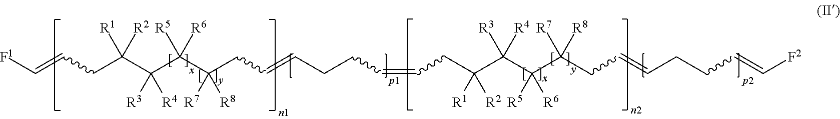

Formulas (II) and (II′) illustrate cases where the main chain of the polymer of formula (I) comprises only two repeating unit, repeated n1+n2 and p1+p2 times respectively.

According to another embodiment of the polymer of formula (I) according to the invention, n1 and n2 are each equal to 0, the polymer having the following formula (III):

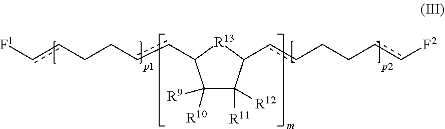

wherein m, p1, p2 F¹, F², R⁹, R¹⁰, R¹¹, R¹² and R¹³ are as previously defined.

According to a particularly preferred form of this embodiment, all the bonds [symbol] of formula (III) are carbon-carbon double bonds, and formula (III) then becomes formula (III′) below:

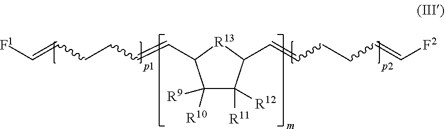

Formulas (III) and (III′) illustrate cases where the main chain of the polymer of formula (I) comprises only two repeating units, respectively repeated (p1+p2) times and m times.

According to another embodiment of the polymer of formula (I) according to the invention, n1, n2 and m are each equal to 0, the polymer having formula (IV) below:

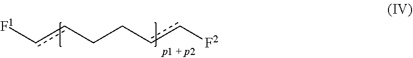

wherein p1, p2, F¹, F² are as defined above.

According to a particularly preferred form of this embodiment, all the bonds [symbol] of formula (IV) are carbon-carbon double bonds, and formula (IV) then becomes formula (IV′) below:

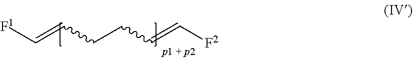

Formulas (IV) and (IV′) illustrate cases where the main chain of the polymer of formula (I) comprises a single repeating unit, repeated p1+p2 times.

The invention also relates to a process for the preparation of a hydrocarbon polymer comprising two exo-vinylene cyclocarbonate end groups of formula (I) according to the invention, said process comprising a “Ring-Opening Metathesis Polymerization” or ROMP step, in the presence:
(a) of a metathesis catalyst;
(b) of a chain transfer agent (hereinafter also referred to as “Chain Transfer Agent” (CTA)) which is selected from a mono or di-exo vinylene cyclocarbonate of the respective formula (B1) or (B2) below:

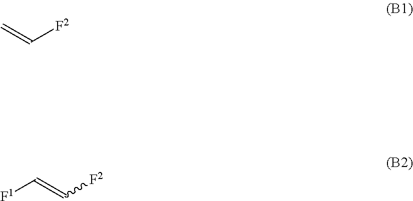

on condition that in the above formulas:
the bond [symbol] is a single carbon-carbon bond geometrically oriented on one end or the other in relation to the double bond (cis or trans);
F¹ and F² are as previously defined;
(c) a compound of formula (C):

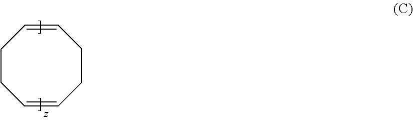

wherein z is as previously defined; and
(d) optionally a compound of formula (D):

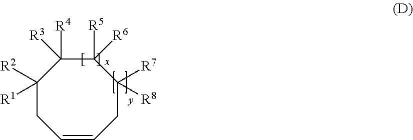

wherein R¹, R², R³, R⁴, R⁵, R⁶, R⁷, R⁸ x and y are as previously defined; and
(e) optionally a compound of formula (E):

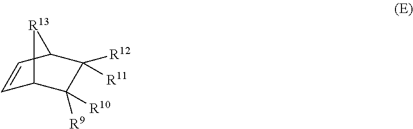

wherein R⁹, R¹⁰, R¹, R¹² et R¹³ are as previously defined;
said polymerization step being further implemented:
for a duration ranging from 2 to 24 hours and at a temperature ranging from 20 to 60° C.; and
with a ratio r equal to the ratio of the number of moles of said CTA:
   to the number of moles of the compound of formula (C), if it is the only reagent other than the CTA used in the reaction, or
   to the sum of the number of moles of the compound of formula (C) and the number of moles of compounds of formula (D) and/or (E), if the compounds of formula (D) and/or (E) are also implemented in the reaction,

within a range of 0.0010 to 1.0.

When the hydrocarbon polymer comprising two exo-vinylene cyclocarbonate end groups according to the invention has a saturated main chain, as envisaged by the formula (1H) defined above, the above preparation process comprises a step of selective hydrogenation of the polymer double bonds.

In the definition of the polymerisation step given above, it is understood that the indefinite article “a”, as it relates to a reagent or to the catalyst used or to the product formed, must to be interpreted as meaning “at least one”, which means, “one or more”.

The duration and temperature of the reaction generally depend on its operating conditions, especially the nature of the solvent used, and in particular the catalytic loading rate. The person skilled in the art is able to adapt them depending on the circumstances.

Thus, preferably, the duration of the polymerisation reaction is between 2 to 10 hours, and the above-defined ratio ranges from 0.0020 to 0.5.

Ring-opening metathesis polymerisation is a reaction well known to the person skilled in the art. It is implemented here in the presence of a particular CTA compound of formula (B1) or (B2).

(a) Metathesis Catalyst:

The metathesis catalyst is preferably a catalyst comprising ruthenium, and even more preferably a Grubbs catalyst,

Such a catalyst is generally a commercial product.

The metathesis catalyst is most often a transition metal catalyst including a catalyst comprising ruthenium generally in the form of ruthenium complex (s) of such as a ruthenium-carbene complex.

Grubbs catalyst, generally refers according to the invention, to a 1^{st} or 2^{nd} generation Grubbs catalyst, but also any other Grubbs type catalyst (ruthenium-carbene type) or Hoveyda-Grubbs accessible to the person skilled in the art, such as the substituted Grubbs catalysts described in U.S. Pat. No. 5,849,851.

A 1^{st} generation Grubbs catalyst is generally of formula (G1):

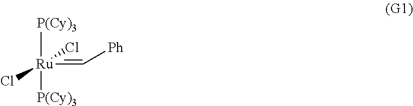

wherein Ph is phenyl, Cy is cyclohexyl, and P (Cy)₃ is a tricyclohexylphosphine group.
The IUPAC name for this compound is: benzylidene-bis (tricyclohexylphosphine) dichlororuthenium (CAS number 172222-30-9). Such a catalyst is available especially from the Aldrich company.

A 2^{nd} generation Grubbs catalyst (or G2) is generally of formula (G2):

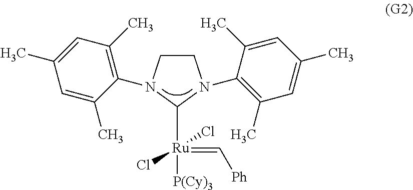

wherein Ph is phenyl and Cy is cyclohexyl.
The IUPAC name of the second generation of this catalyst is benzylidene [1,3-bis (2,4,6-trimethylphenyl)-2-imidazolidinylidene] dichloro (tricyclohexylphosphine) ruthenium (CAS number 246047-72-3). This catalyst is also available from the Aldrich company.

(b) CTA of Formula (B1) or (B2):

According to a first embodiment of the preparation process according to the invention (called “monofunctional CTA route”), the CTA used is of formula (B1), also represented by the equivalent formula (B′1) below:

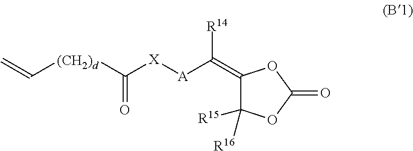

wherein d, X, A, R¹⁴, R¹⁵ and R¹⁶ are as previously defined.

The compound of formula (B1) can be obtained according to diagram (1) below, following the procedures described in patent applications DE1098953 and DE3433403:

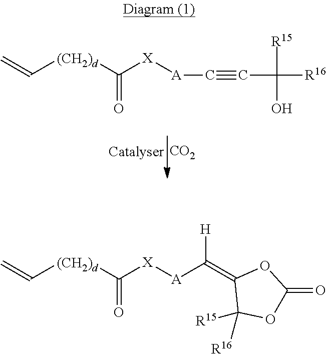

The CTA corresponding to the monofunctional CTA route and corresponding to the formula

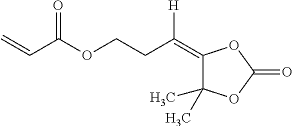 [SMILES: C=CC(=O)OCC/C=C1/OC(=O)OC1(C)C]

is called [(5,5-dimethyl-2-oxo-1,3-dioxolan-4-ylidene) propyl] acrylate. It is hereinafter referred to as CTA¹.

The CTA also corresponding to the monofunctional CTA route, but corresponding to the formula

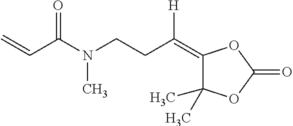 [SMILES: C=CC(=O)N(C)CC/C=C1/OC(=O)OC1(C)C]

is called [N-methyl,(5,5-dimethyl-2-oxo-1,3-dioxolan-4-ylidene)propyl]acrylamide. It is hereinafter referred to as CTA².

According to a second embodiment of the preparation process according to the invention (called “difunctional CTA route”), the CTA used is of formula (B2), also represented by the equivalent formula (B′2) below:

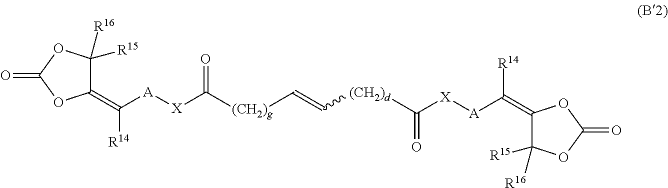

wherein g, d, X, A, R¹⁴, R¹⁵ et R¹⁶ are as previously defined.

The compound of formula (B2) can be obtained according to diagram (2) below, corresponding to an original variant of diagram (1):

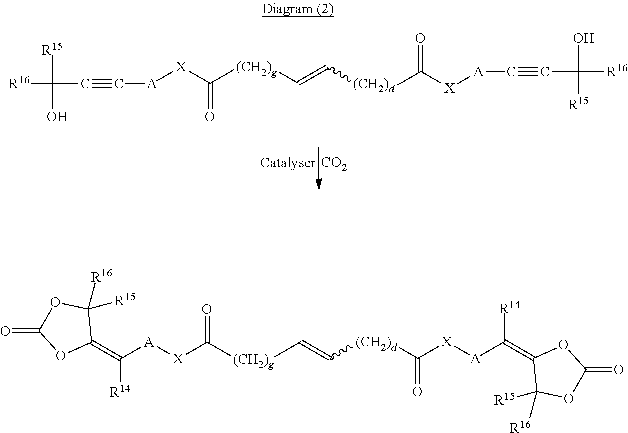

The CTA corresponding to the difunctional CTA route and corresponding to the formula

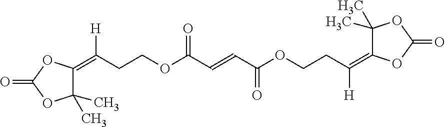 [SMILES: CC1(C)OC(=O)O/C1=C/CCOC(=O)/C=C/C(=O)OCC/C=C1/OC(=O)OC1(C)C]

is called bis [(5,5-dimethyl-2-oxo-1,3-dioxolan-4-ylidene) propyl] fumarate acrylate. It is hereinafter referred to as CTA³.

The CTA corresponding to the difunctional CTA route and corresponding to the formula

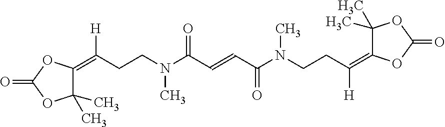 [SMILES: CN(CC/C=C1/OC(=O)OC1(C)C)C(=O)/C=C/C(=O)N(C)CC/C=C1/OC(=O)OC1(C)C]

is called bis [(5,5-dimethyl-2-oxo-1,3-dioxolan-4-ylidene) propyl]fumaramide. It is hereinafter referred to as CTA⁴.

(c) Compound of Formula (C):

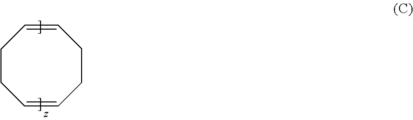

The cyclic compound of formula (C) generally comprises from 8 to 32 carbon atoms.

Preferably, it is selected from the group formed by:
1,5-cyclooctadiene (hereinafter referred to as COD) of formula:

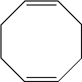

(corresponding to z=1)
and 1,5,9-cyclododecatriene (hereinafter referred to as CDT) composed of 12 carbon atoms of formula:

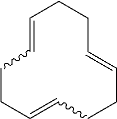 [SMILES: C1=CCC/C=C/CCC=CCC1]

(corresponding to z=2)

these 2 compounds being commercially available from the Evonik Degussa and Arkema France companies.

(d) Compound of Formula (D):

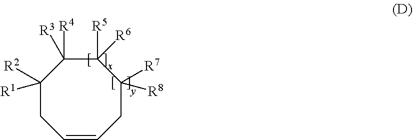

The compound of formula (D) generally comprises from 6 to 30, preferably from 6 to 22, carbon atoms.

Preferably:
R¹, R², R³, R⁴, R⁵, R⁶, R⁷ and R⁸ represent a hydrogen atom or an alkyl radical comprising from 1 to 14 carbon atoms, and even more preferably from 1 to 8;
the integers x and y range from 0 to 2, the sum x+y ranging from 0 to 2.

According to an even more preferred variant:

x is equal to 1 and y is 1 and/or
at most one of the groups selected from (R¹, R², R³, R⁴, R⁵, R⁶, R⁷ and R⁸) is a C₁-C₈ alkyl radical and all the others represent a hydrogen atom.

The compound of formula (D) is especially selected from:
cycloheptene, cyclooctene, cyclononene, cyclodecene, cycloundecene and cyclododecene.

5-epoxy-cyclooctene, of formula:

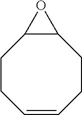

(available from Aldrich),

5-oxocyclooctene, of formula:

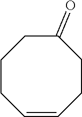

or from a 5-alkyl-cyclooctene, of formula:

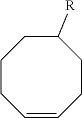

wherein R is an alkyl radical with 1 to 22 carbon atoms, preferably 1 to 14; R being for example, the radical n-hexyle.

The compounds corresponding to the last 2 above-developed formulas can be prepared by a process generalising the reaction scheme of example 9, in particular by carrying out the alkylation of intermediate 2 with a suitable Grignard reagent.

Among these compounds, cyclooctene and 5-n-hexylcyclooctene are particularly preferred.

(e) Compound of Formula (E):

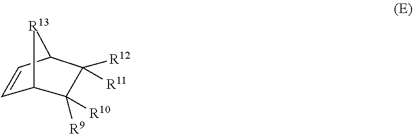

The compound of formula (E) generally comprises from 6 to 30, preferably from 6 to 22, carbon atoms.

Preferably:
R⁹, R¹⁰, R¹¹ and R¹² represent a hydrogen atom or an alkyl or alkoxycarbonyl radical comprising from 1 to 14 carbon atoms, and even more preferably from 1 to 8;
the radical R⁰, included in the group —NR⁰ which is one of the definitions of R¹³, is a linear radical comprising from 1 to 14 carbon atoms.

According to an even more preferred variant:
at most one of the groups selected from (R⁹, R¹⁰, R¹¹ and R¹²) is a C₁-C₈ alkoxycarbonyl radical and all others represent a hydrogen atom; and/or
R¹³, represents a radical —CH₂— or an oxygen atom.

The compound of formula (E) is especially selected from:
norbornene, of the following formula:

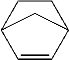

norbornadiene, of the following formula:

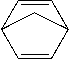

dicyclopentadiene, of the following formula:

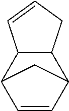

7-oxanorbornene, of the following formula:

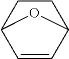

7-oxanorbornadiene, of the following formula:

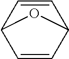

5-ethylidene-2-norbornene, of the following formula:

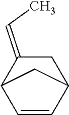

or alternately, 5-norbonene-2-methylacetate, of the following formula:

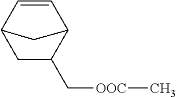

The compound of formula (E) may also be selected from compounds of the following formulas:

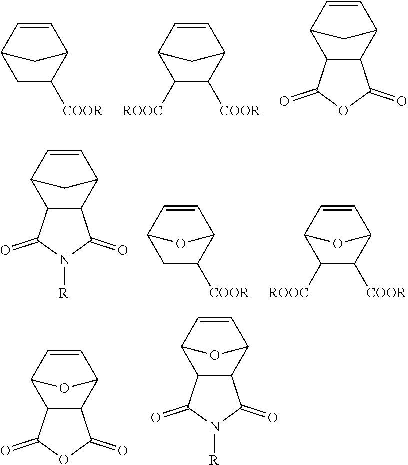

wherein R is as defined above for the compound of formula (D).

The compound of formula (E) may also be selected from the group formed by the adducts resulting from the Diels-Alder reaction using cyclopentadiene or furan as feedstock as well as the norbornene derivatives such as branched norbornenes as described in WO2001/04173 (for example: isobornyl norbornene carboxylate, phenyl norbornene carboxylate, ethylhexyl norbornene carboxylate, phenoxyethyl norbornene carboxylate and alkyl dicarboxymide norbornene, the alkyl generally containing between 3 to 8 carbon atoms) and branched norbornenes as described in WO2011/038057 (norbornene dicarboxylic anhydrides and optionally 7-oxanorbornene dicarboxylic anhydrides).

The most preferred among the various compounds of formula (E) mentioned include methyl norbornene, 7-oxanorbornene, 5-norbornene-2-carboxylate, of formula:

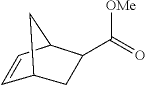 [SMILES: COC(=O)C1CC2C=CC1C2]

methyl 5-oxanorbornene-2-carboxylate, of formula:

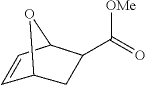 [SMILES: COC(=O)C1CC2C=CC1O2]

or dicyclopentadiene.

The ring-opening metathesis polymerization step, included in the process according to the invention, is generally carried out in the presence of at least one solvent, generally selected from the group formed by the aqueous or organic solvents typically used in the polymerization reactions and which are inert under the polymerization conditions described above.

Examples of a possible solvent include aromatic hydrocarbons, chlorinated hydrocarbons, ethers, aliphatic hydrocarbons, alcohols, water or mixtures thereof.

Preferably, the solvent is selected from the group consisting of benzene, toluene, para-xylene, methylene chloride, dichloroethane, dichlorobenzene, chlorobenzene, tetrahydrofuran, diethyl ether, pentane, hexane, heptane, methanol, ethanol, water or mixtures thereof.

More preferably, the solvent is selected from the group consisting of benzene, toluene, para-xylene, methylene chloride, dichloroethane, dichlorobenzene, chlorobenzene, tetrahydrofuran, diethyl ether, pentane, hexane, heptane, methanol, ethanol, and mixtures thereof.

More preferably, the solvent is toluene, heptane, or a mixture of toluene and methylene chloride. The solubility of the polymer formed during the polymerization reaction depends generally and mainly on the choice of solvent and the molar mass of the polymer obtained. The reaction can also be carried out without solvent.

The invention also relates to the use of hydrocarbon polymer as adhesive, comprising two exo-vinylene cyclocarbonate end groups, as defined above, in a mixture with an amine compound comprising at least two amine groups, for example selected from diamines, triamines and higher homologs.

Said hydrocarbon polymer reacts with the amine compound to form a polyurethane.

The amine compounds that can be used according to the invention are preferably such that all the amine groups are primary amine groups. These amino compounds can be oligomers. These oligomers generally have a number-average molecular weight less than 2000 g/mol.

The temperature at which the polymer with exo-vinylene cyclocarbonate end groups can be used as an adhesive, in a mixture with the amine compound, is a temperature below 100° C., or even at room temperature (i.e. approximately 23° C.) when the above-mentioned polymer is liquid at 23° C.

It has been observed that under identical temperature conditions, and in the presence of the same amine compound, the forming reaction of the constitutive polyurethane of the adhesive seal is faster than that associated with use as hydrocarbon-terminated polymer adhesive (2-oxo-1,3-dioxolan-4-yl according to application WO 2014/091173.

The quantities hydrocarbon polymer and amine compound correspond to stoichiometric quantities, meaning that the molar ratio of the number of exo-vinylene cyclocarbonate groups to the number of amine groups ranges from 0.8 to 1.2, preferably from 0.9 to 1.1, or about 1.0.

In practice, the hydrocarbon polymer and amine compound, used as hardener, are advantageously comprised each in a component of two-component composition which is made available to the user. The latter thus proceeds, at the time of use of the adhesive, to the mixture of these 2 components, possibly hot, so as to obtain a liquid adhesive composition.

The invention also relates to a method of bonding two substrates by gluing, comprising:
coating on at least one of the two substrates to be bonded with a liquid adhesive composition obtained by mixing an amine compound comprising at least two amine groups with the hydrocarbon polymer comprising two exo-vinylene cyclocarbonate end groups as defined above; then
the effective contact of the two substrates.

The liquid adhesive composition is either the adhesive composition comprising the said compounds and polymer in liquid state at ambient temperature, or the hot melt adhesive composition. The person skilled in the art is able to proceed such that the adhesive composition used is in liquid form at the time of use.

Coating of the liquid adhesive composition is preferably made in the form of layer thickness in a range of 0.3 to 5 mm, preferably 1 to 3 mm, on at least one out of two surfaces which respectively belong to the two substrates to be bonded, and which are intended to be brought into contact with one another according to a tangency surface. The effective contact of the two substrates is then implemented according to their tangency surface.

Naturally, coating and contacting must be carried out within a compatible time interval, as it is well known to the person skilled in the art, that is, before the adhesive layer applied to the substrate loses its ability to fix this substrate to another substrate using bonding. Generally, the polycondensation of hydrocarbon polymer with amine compound begins to occur during coating, and then continues to occur during the contacting phase of the two substrates.

Suitable substrates are, for example, inorganic substrates such as glass, ceramics, concrete, metals or alloys (such as aluminium alloys, steel, non-ferrous metals and galvanised metals); or organic substrates such as wood, plastics such as PVC, polycarbonate, PMMA, polyethylene, polypropylene, polyesters, epoxy resins; metal substrates and paint-coated composites (as in the automotive industry).

The following examples are provided purely by way of illustration of the invention, and should not be interpreted to limit its scope.

### EXAMPLE 1: POLYMERISATION OF 1,5-CYCLOOCTADIENE (CYCLOOLEFIN OF FORMULA (C)) IN THE PRESENCE OF CTA¹

Commercially available 1,5-cyclooctadiene (COD) is used and as a chain transfer agent, the CTA¹ of the formula:

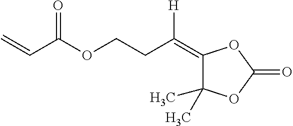 [SMILES: C=CC(=O)OCC/C=C1/OC(=O)OC1(C)C]

1,5-cyclooctadiene (10.8 mmol), benzoquinone (0.54 mmol) and dry CH₂Cl₂ (5 ml) are inserted into a 20 ml flask in which a Teflon® coated magnetic stirring bar has also been placed. The flask and its contents are then put under argon.

The CTA¹ compound (0.54 mmol) is then added while stirring to the flask using a syringe. Reagent ratios expressed in number of moles: CTA¹/COD is 0.050.

The flask is then immersed in an oil bath at 40° C., and then we proceed immediately to the addition, via cannula, of G2 catalyst defined above (5.4 mol) solution in CH₂Cl₂ (2 ml).

The reaction mixture becomes very viscous within 2 minutes. The viscosity then slowly decreases for the next 10 minutes.

After 8 hours from the addition of the catalyst, the product present in the flask is removed after evaporation of the solvent under vacuum. The product is then recovered in the form of a colourless solid powder, after precipitation in methanol, filtration and drying at 20° C. under vacuum, with a yield greater than 90%.

NMR ¹H (CDCl₃, 500 MHz, 25° C.) and ¹³C (CDCl₃, 125 MHz, 25° C.) analyses of said polymer confirm the following structure:

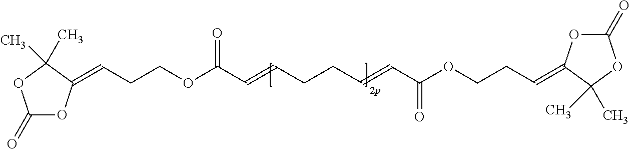

This structure is well covered by formula (IV′) defined above.

The number-average molecular weight Mn, measured by NMR, is 6800 g/mol.

The polymolecularity index equal to the Mw/Mn ratio (measured by polystyrene standard steric exclusion chromatography) is 1.60.

### EXAMPLE 2: POLYMERIZATION OF 1,5,9-CYCLODODECATRIENE (CYCLOOLEFIN OF FORMULA (C)) IN THE PRESENCE OF CTA²

Example 1 is repeated while replacing:
COD by 1,5,9-cyclododecatriene (known as CDT) which is commercially available, for example from the Sigma Aldrich company; and
CTA¹ by CTA² of formula:

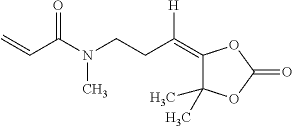 [SMILES: C=CC(=O)N(C)CC/C=C1/OC(=O)OC1(C)C]

A polymer is also recovered in the form of a colourless solid powder whose NMR ¹H/¹³C analysis confirms the structure below:

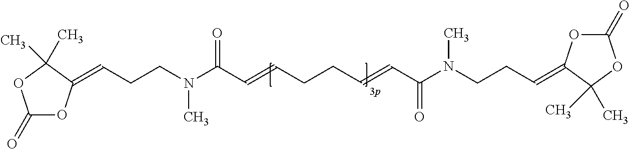

which is equally covered by formula (IV′) defined above.

The number-average molecular weight Mn and the polydispersity index are, respectively, 6900 g/mol and 1.80.

### EXAMPLE 3: POLYMERIZATION OF 1,5,9-CYCLODODECATRIENE (CYCLOOLEFIN OF FORMULA (C)) IN THE PRESENCE OF CTA³

Example 2 is repeated by replacing the CTA as a chain transfer agent, CTA² by the CTA³ of formula:

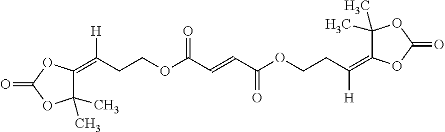 [SMILES: CC1(C)OC(=O)O/C1=C/CCOC(=O)/C=C/C(=O)OCC/C=C1/OC(=O)OC1(C)C]

and at the rate of 0.27 mmol CTA³.

Reagent ratios expressed in number of moles: CTA³/COD is 0.025.

A polymer is also recovered in the form of a colourless solid powder whose NMR ¹H/¹³C analysis confirms the structure below:

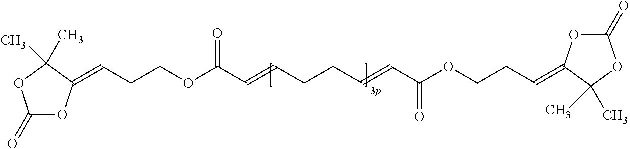

This structure is well covered by formula (IV′) defined above.

The number-average molecular weight Mn and the polydispersity index are, respectively, 6900 g/mol and 1.80.

### EXAMPLE 4: POLYMERIZATION OF 1,5,9-CYCLODODECATRIENE (CYCLOOLEFIN OF FORMULA (C)) IN THE PRESENCE OF CTA⁴

Example 3 is repeated by replacing the CTA as a chain transfer agent, CTA³, by the CTA⁴ of formula:

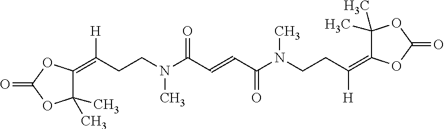 [SMILES: CN(CC/C=C1/OC(=O)OC1(C)C)C(=O)/C=C/C(=O)N(C)CC/C=C1/OC(=O)OC1(C)C]

A polymer is also recovered in the form of a colourless solid powder the NMR ¹H/¹³C analysis of which confirms a structure identical to that obtained for example 2.

### EXAMPLE 5: POLYMERISATION OF CDT AND NORBORNENE (CYCLOOLEFIN OF FORMULA (E)) IN THE PRESENCE OF CTA³

Example 3 is repeated while replacing the 10.8 mmol CDT with a mixture of 5.4 mmol CDT, 5.4 mmol norbornene, of the formula:

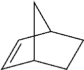

and available from the Sigma Aldrich company.

Reagent ratios expressed in number of moles: CTA³/(CDT+norbornene) is 0.025.

A liquid copolymer is obtained the RMN (¹H NMR and ¹³C NMR analysis of which confirms the structure below:

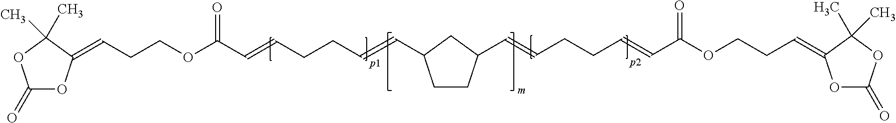

This structure is well covered by formula (III′) defined above.

The number-average molecular weight Mn and the polydispersity index are, respectively, 5500 g/mol and 1.60.

### EXAMPLE 6: POLYMERISATION OF CDT AND METHYL 5-NORBORNENE-2-CARBOXYLATE(CYCLOOLEFIN OF FORMULA (E)) IN THE PRESENCE OF CTA³

Example 5 is repeated while replacing norbornene with methyl 5-norbornene-2-carboxylate, of formula:

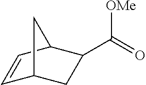 [SMILES: COC(=O)C1CC2C=CC1C2]

and available from Sigma Aldrich.

A copolymer which is liquid at room temperature is also obtained, the NMR analysis of which confirms the following structure:

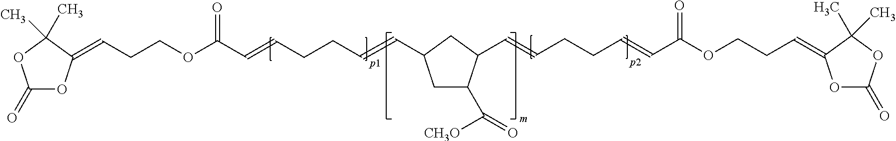

This structure is well covered by formula (III′) defined above.

The number-average molecular weight Mn and the polydispersity index are, respectively, 6600 g/mol and 1.70.

### EXAMPLE 7: POLYMERISATION OF CDT AND METHYL 5-OXANORBORNENE-2-CARBOXYLATE(CYCLOOLEFIN OF FORMULA (E)) IN THE PRESENCE OF CTA³

Example 5 is repeated while replacing norbornene with methyl 5-oxanorbornene-2-carboxylate, of formula:

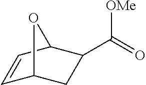 [SMILES: COC(=O)C1CC2C=CC1O2]

and available from the Boc Sciences company.

A copolymer, liquid at room temperature, is also obtained, its NMR analysis confirms the structure:

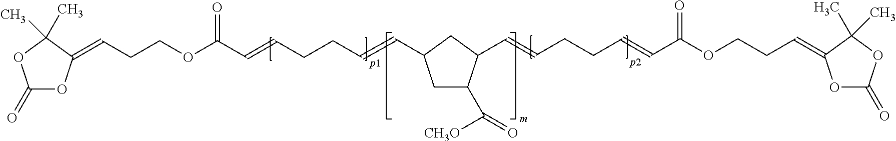

which is well covered by formula (III′) defined above.

The number-average molecular weight Mn and the polydispersity index are, 6500 g/mol and 1.70 respectively.

### EXAMPLE 8: POLYMERISATION OF CDT AND DICYCLOPENTADIENE(CYCLOOLEFIN OF FORMULA (E)) IN THE PRESENCE OF CTA³

Example 5 is repeated while replacing norbornene with dicyclopentadiene, of formula:

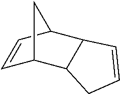

and available from the Sigma Aldrich company.

A copolymer which is liquid at room temperature is also obtained, the NMR analysis of which confirms the following structure:

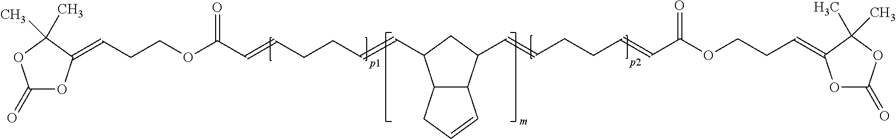

which is well covered by formula (III′) defined above.

The number-average molecular weight Mn and the polydispersity index are, respectively, 6800 g/mol and 1.80.

### EXAMPLE 9: POLYMERISATION OF CDT AND 5-N-HEXYLCYCLOOCTENE(CYCLOOLEFIN OF FORMULA (D)) IN THE PRESENCE OF CTA³

The 5-n-hexyl-cyclooctene used in this example was synthesized according to the route indicated in the reaction diagram below (see compound n° 5):

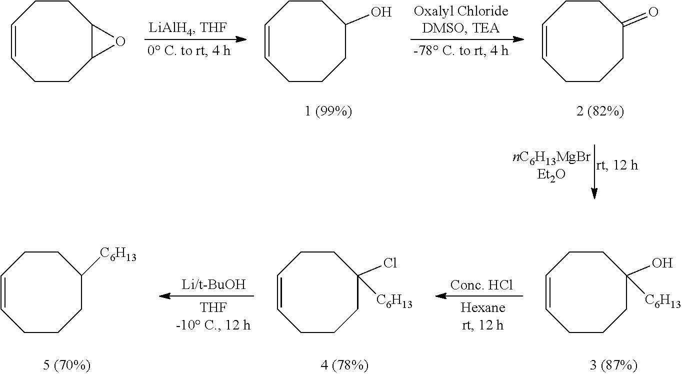

Raw materials (especially 5,6-epoxycyclooctene), reactants and solvents used in these syntheses are commercial products from the Sigma Aldrich company. For further details, reference is made to the publication of A. Diallo et al. (Polymer Chemistry, Vol 5, Issue 7, Apr. 7, 2014, pp 2583-2591), or to Kobayashi et al J. Am. Chem. Soc. 2011, 133, pp 5794-5797).

Example 5 is repeated while replacing norbornene with 5-n-hexyl-cyclooctene.

A copolymer which is liquid at room temperature is also obtained, the NMR analysis of which confirms the following structure:

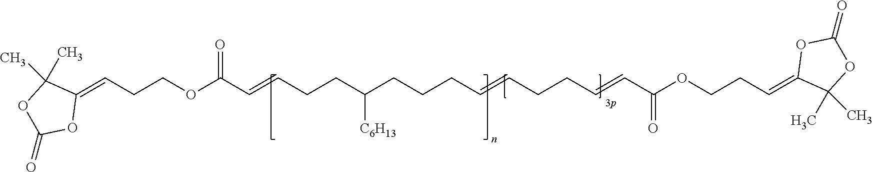

which is well covered by formula (II′) defined above.

The number-average molecular weight Mn and the polydispersity index are, respectively, 7000 g/mol and 1.80.

### EXAMPLE 10: POLYMERISATION OF CDT, CYCLOOCTENE (CYCLOOLEFIN OF FORMULA (D)) AND NORBORNENE (CYCLOOLEFIN OF FORMULA (E)) IN THE PRESENCE OF CTA³

Example 3 is repeated while replacing the 10.8 mmol CDT with a mixture of 3.6 mmol CDT, 3.6 mmol cyclooctene and 3.6 mmol norbornene.

Reagent ratios expressed in number of moles: CTA³/(CDT+cyclooctene+norbornene) is 0.025.

After 8 hours from the addition of the catalyst, the product in the flask is removed after evaporation of the solvent under vacuum. The product is then recovered in the form of a liquid at ambient temperature, after precipitation in methanol, filtration and drying at 20° C. under vacuum, with a yield greater than 90%.

The NMR analysis of the polymer obtained confirms the following structure:

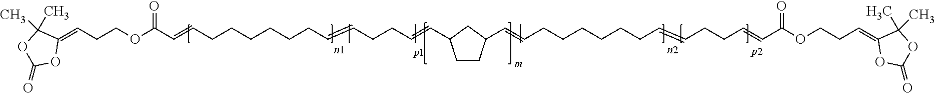

The number-average molecular weight Mn and the polydispersity index are, respectively, 6900 g/mol and 1.70.

### EXAMPLE 11: SYNTHESIS OF A POLYURETHANE BY REACTION OF THE POLYMER OF EXAMPLE 1 WITH A DIAMINE AT 80° C.

A mixture of the polyolefin of example 1 (solid at room temperature) with a primary diamine of the polyether diamine type (JEFFAMINE EDR 176, Huntsman) in a stoichiometric ratio, is reacted at 80° C., and this during a duration corresponding to the complete disappearance of the infrared band which is a characteristic of the 1.3-dioxolan-2-one groups (at 1800 cm−¹), and the appearance of the characteristic bands of carbamate bond (band at 1700 cm−¹ in Infra-Red).

This reaction time is less than 3 hours.

### EXAMPLE 12: SYNTHESIS OF A POLYURETHANE BY REACTION OF THE POLYMER OF EXAMPLE 5 WITH A DIAMINE AT 80° C.

Example 11 is repeated with the polyolefin of example 5 (in the form of a viscous liquid) by reacting the mixture at 80° C.

The reaction time is less than 3 hours.

### EXAMPLE 13: SYNTHESIS OF A POLYURETHANE BY REACTION OF THE POLYMER OF EXAMPLE 9 WITH A DIAMINE AT 60° C.

Example 12 is repeated with the polyolefin of example 9 (in the form of a viscous liquid) by reacting the mixture at 60° C.

The reaction time is less than 3 hours.

1. A hydrocarbon polymer comprising two exo-vinylene cyclocarbonate end groups, said hydrocarbon polymer having formula (I): 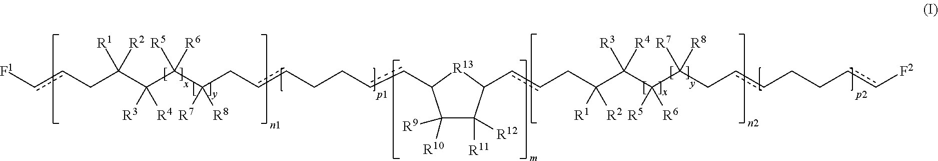
wherein:
F¹ and F² are the exo-vinylene cyclocarbonate monovalent radicals of the respective formulas (I1a) and (I1b): 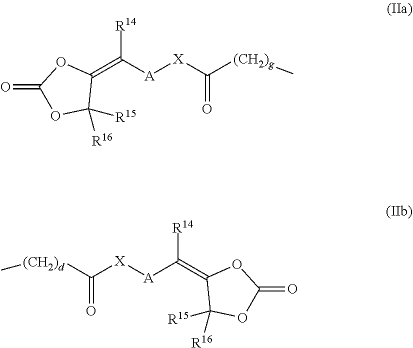
wherein:
g and d, identical or different, represent an integer equal to 0, 1, 2 or 3;
A represents a C1-C6 alkylene divalent radical;
X is an oxygen atom or a nitrogen group NR¹⁷ where R¹⁷ is a C1-C6 alkyl group;
R¹⁴, R¹⁵ and R¹⁶, which may be identical or different, each represent a hydrogen atom, a C1-C6 alkyl group, a C5-C6 cycloalkyl group, a phenyl group or an alkylphenyl group with a C1-C4 alkyl chain;
each carbon-carbon bond of the main chain of the polymer, denoted [symbol] represents a double bond or a single bond, according to the valence rules of organic chemistry;
R¹, R², R³, R⁴, R⁵, R⁶, R⁷ and R⁸, identical or different, represent:
a hydrogen or halogen atom; or
a radical comprising from 1 to 22 carbon atoms selected from alkyl, alkenyl, alkoxycarbonyl, alkenyloxycarbonyl, alkylcarbonyloxy and alkenylcarbonyloxy, the hydrocarbon chain of said radical possibly being interrupted by at least one oxygen atom or one sulphur atom; in addition: —at least one of the groups R¹ to R⁸ can form, with at least one other R¹ to R⁸ group including the carbon atom (s) to which said groups are attached, a saturated or unsaturated, optionally substituted, hydrocarbon ring or heterocycle comprising between 3 to 10 links; and
at least one of the pairs (R¹, R²), (R³, R⁴), (R⁵, R⁶) and (R⁷, R⁸) can form, with the carbon atom to which said pair is connected, a carbonyl group C═O or a group of 2 carbon atoms connected by a double bond: C═C, the other carbon atom carrying 2 substituents selected from a hydrogen atom or a C₁-C₄ alkyl radical;
x and y are integers, identical or different, ranging from 0 to 6, the sum x+y ranging from 0 to 6;
R⁹, R¹⁰, R¹¹ and R¹², identical or different, represent:
a hydrogen or halogen atom; or
a radical comprising from 1 to 22 carbon atoms and selected from alkyl, alkenyl, alkoxycarbonyl, alkenyloxycarbonyl, alkylcarbonyloxy, alkenylcarbonyloxy and alkylcarbonyloxyalkyl, the hydrocarbon chain of said radical possibly being interrupted by at least one oxygen atom or one sulphur atom; in addition:
at least one of the groups R⁹ to R¹² can form, with at least one other R⁹ to R¹² group including the carbon atom or atoms to which said groups are attached, a saturated or unsaturated, optionally substituted, hydrocarbon ring or heterocycle comprising from 3 to 10 links; and
at least one of the pairs (R⁹, R¹⁰) and (R¹¹, R¹²) can form with the carbon atom to which said pair is connected, a group of 2 carbon atoms connected by a double bond: C═C, the other carbon atom carrying 2 substituents selected from a hydrogen atom or a radical C₁-C₄ alkyl radical; and
the carbon atom bearing one of the groups of the pair (R⁹, R¹⁰), can be connected to the carbon atom bearing one of the groups of the pair (R¹¹, R¹²) by a double bond, provided that, in accordance with valence rules, only one of the groups of each of these 2 pairs is present;
R¹³ represents:
an oxygen or sulphur atom, or
a divalent radical —CH₂—, —C(═O)— or —NR⁰— wherein R⁰ is an alkyl or alkenyl radical comprising from 1 to 22 carbon atoms;
n1 and n2, which are identical or different, are each an integer or zero, whose sum is denoted by n;
m is an integer greater than or equal to 0;
p1 and p2, which are identical or different, are each an integer or zero, the sum p1+p2 of which is non-zero and satisfies the equation: p1+p2=qx (z+1)
wherein:
q is an integer greater than 0; and
z is an integer ranging from 1 to 5; and
n1, n2, m, p1 and p2 further being such that a number-average molecular weight Mn of the polymer of formula (I) is comprised in a range from 400 to 100,000 g/mol and its polymolecularity index is comprised in a range from 1.0 to 3.0; the said Mn and polymolecularity index being measured by steric exclusion chromatography with implementation of a PolyStyrene calibration.

2. Hydrocarbon polymer according to claim 1, characterized in that:
g or d are equal to 0;
A represents a C1-C3 alkylene divalent radical;
X is an oxygen atom or a nitrogen group NR¹⁷ where R¹⁷ is a C1-C3 alkyl group;
R¹⁴ is a hydrogen atom;
R¹⁵ and R¹⁶, identical or different, each represent a C1-C3 alkyl group;
R¹, R², R³, R⁴, R⁵, R⁶, R⁷ and R⁸ represent a hydrogen atom or an alkyl radical comprising from 1 to 14 carbon atoms;
the integers x and y are in a range from 0 to 2, the sum x+y ranging from 0 to 2;
R⁹, R¹⁰, R¹ and R¹² represent a hydrogen atom or a radical the hydrocarbon portion of which comprises from 1 to 14 carbon atoms;
z is an integer equal to 1 or 2; and/or
the number-average molecular weight Mn ranges from 1000 to 50,000 g/mol, and the polydispersity index ranges from 1.4 to 2.0.

3. Hydrocarbon polymer according to claim 1, characterized in that:
when m is non-zero and n1 and n2 are each equal to 0, then the ratio: m/(p1+p2+m) ranges from 30 to 70%; or
when m is equal to 0 and the sum n1+n2 is non-zero, then at least one of the groups R, R², R³, R⁴, R⁵, R⁶, R⁷ and R⁸ is other than a hydrogen atom, and ratio: (n1+n2)/(p1+p2+n1+n2) ranges from 30 to 70%; or
when m is non-zero, the sum n1+n2 is non-zero and that each of the groups R¹, R², R³, R⁴, R⁵, R⁶, R⁷ and R⁸ is a hydrogen atom, then the ratio: m/(p1+p2+n1+n2+m) is in the range of 30 to 70%;
when m is equal to non-zero and the sum n1+n2 is non-zero, then at least one of the groups R¹, R², R³, R⁴, R⁵, R⁶, R⁷ and R⁸ is other than a hydrogen atom, thus the ratio: (m+n1+n2)/(p1+p2+n1+n2+m) ranges from 30 to 70%.

4. Hydrocarbon polymer according to claim 1, characterised in that it has the following formula (I′):

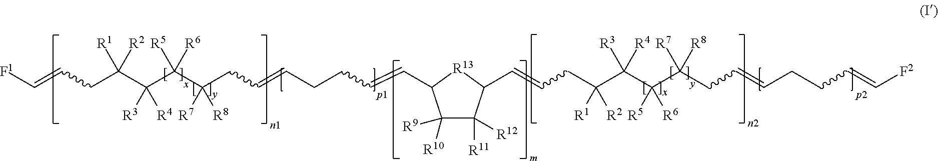

5. Hydrocarbon polymer according to claim 1, characterised in that it has the following formula (II):

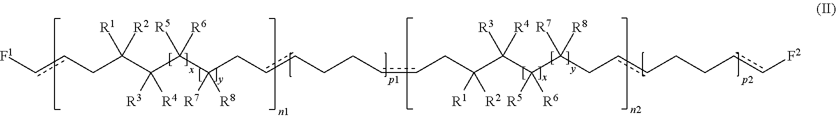

6. Hydrocarbon polymer according to claim 5, characterized in that it has the following formula (II′):

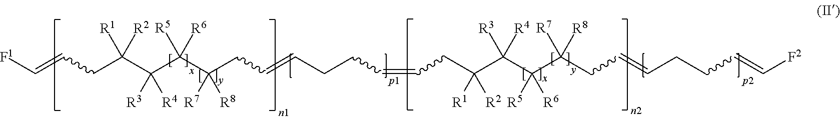

7. Hydrocarbon polymer according to claim 1, characterized in that n1 and n2 are each equal to 0, the polymer having the following formula (III):

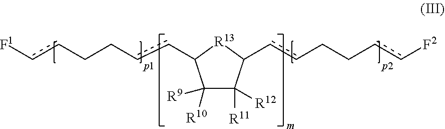

8. Hydrocarbon polymer according to claim 7, characterised in that it has the following formula (III′):

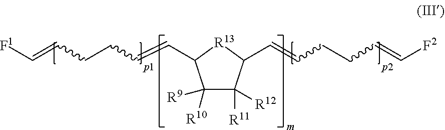

9. Hydrocarbon polymer according to claim 1, characterised in that n1, n2 and m are each equal to 0, the polymer being of formula (IV) below:

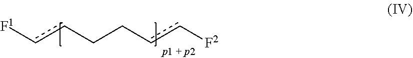

10. Hydrocarbon polymer according to claim 9, characterised in that it has the following formula (IV′):

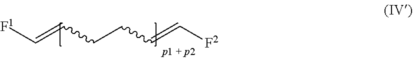

11. Process for preparing a hydrocarbon polymer as defined in claim 1, said process comprising a ring-opening metathesis polymerization step, in the presence of:
(a) a 2^{nd} generation Grubbs ruthenium carbene metathesis catalyst;
(b) a chain transfer agent selected from a mono or di-exo vinylene cyclocarbonate of the respective formula (B1) or (B2): 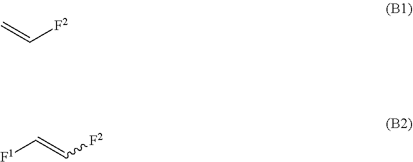
on condition that in the above formulas:
the bond [symbol] is a single carbon-carbon bond geometrically oriented on one end or the other in relation to the double bond;
(c) a compound of formula (C): 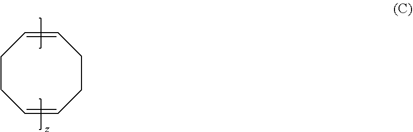
(d) optionally a compound of formula (D): 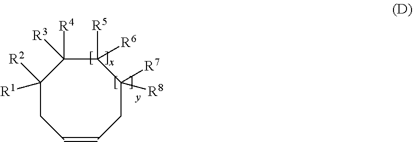
and
(e) optionally a compound of formula (E): 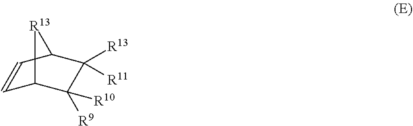
said polymerization step being further implemented:
for a duration ranging from 2 to 24 hours and at a temperature ranging from 20 to 60° C.; and
with a ratio r equal to the ratio of the number of moles of said CTA:
to the number of moles of the compound of formula (C), if it is the only reagent other than the CTA used in the reaction, or
to the sum of the number of moles of the compound of formula (C) and the number of moles of compounds of formula (D) and/or (E), if the compounds of formula (D) and/or (E) are also implemented in the reaction,
within a range of 0.0010 to 1.0.

12. A hydrocarbon polymer adhesive comprising a polymer as defined in claim 1, in a mixture with an amine compound comprising at least two amine groups.

13. A method of bonding two substrates comprising:
coating on at least one of the two substrates to be assembled with a liquid adhesive composition obtained by mixing an amine compound comprising at least two amine groups with hydrocarbon polymer as defined in claim 1; then
the effective contact of the two substrates.
